(19) United States
(12) Patent Application Publication
(10) Pub. No.: US 2018/0123912 A1
(43) Pub. Date: May 3, 2018

(54) INTELLIGENTLY SUGGESTING COMPUTING RESOURCES TO COMPUTER NETWORK USERS

(71) Applicant: International Business Machines Corporation, Armonk, NY (US)

(72) Inventors: Jay S. Bryant, Rochester, MN (US); James E. Carey, Rochester, MN (US); John M. Santosuosso, Rochester, MN (US)

(21) Appl. No.: 15/341,026

(22) Filed: Nov. 2, 2016

(51) Int. Cl. H04L 12/24; H04L 29/08; H04L 12/911; G06Q 10/06

(52) U.S. Cl. CPC H04L 41/5038; H04L 67/10; G06Q 10/0631; H04L 41/5096; H04L 47/822; H04L 67/16

(57) ABSTRACT

A method of improving resource performance in a hybrid cloud environment is provided. The hybrid cloud environment includes multiple cloud systems, each of which includes at least one resource that utilizes an application. The application of a resource is executed on a cloud system of a user. Performance of the application for a user is monitored to determine a base performance of the resource on the cloud system. The application with an additional resource is concurrently run on a shadow cloud system to determine an additional base performance of the additional resource, where the additional base performance of the additional resource, at least in part, defines a performance gain of the additional resource on the shadow cloud system. The user is notified of the performance gain of the additional resource on the cloud system, and a cloud service provider upsells the additional resource to the user.

### BACKGROUND

The present invention relates generally to the field of providing users with computing resources to run code over a communications network, and more particularly to providing paying customers with cloud resources deployed in a cloud.

“Network implemented computing resource” (NICR) refers to any computing resource that can be exploited by a user to run code over a communication network (for example, a cloud). NICRs include hardware resources (processor cores, physical volatile memory, physical persistent storage, communication bandwidth, etc.) and software resources (for example, virtual machines (VMs), containers, software programs, operating systems, etc.)

Conventionally, cloud providers sell the use of NICRs in their clouds to users (also herein referred to as “customers”). Some pricing models that have been used, or at least suggested, in this context include the following: (i) pay-per-use; (ii) flat rates; (iii) free, freemium or advertiser supported; (iv) supported through selling consumer preference and analytics to third parties; (v) pay what you like; (vi) dynamic pricing and non-uniform (differential) pricing (for example, different computing resources are priced differently based on location, time of day, price of a given computing time slot varies with level of demand, etc.; (vii) pay for quality or priority; (viii) congestion pricing; (ix) business partnerships and/or (x) combinations of two, or more, of the foregoing pricing models. As used herein, the word “price” refers to any form of good and valuable consideration, and is not limited to prices expressed in using currency.

### SUMMARY

In one aspect of the present application, a method of improving resource performance in a hybrid cloud environment, wherein the hybrid cloud environment including multiple cloud systems, each of which includes at least one resource that utilizes an application, wherein the application of a resource of the at least one resource is executed on a cloud system of a user, and the cloud system being a cloud system of the multiple cloud systems of the hybrid cloud environment is provided. The method includes: monitoring performance of the application for a user to determine a base performance of the resource of the at least one resource on the cloud system; running the application with an additional resource of the at least one resource to determine an additional base performance of the additional resource, the additional base performance being determined on a shadow cloud system of the multiple cloud systems, wherein the additional base performance of the additional resource, at least in part, defines a performance gain of the additional resource on the shadow cloud system; and notifying the user of the performance gain of the additional resource on the cloud system, and upselling the additional resource to the user for the enhanced performance of the application.

According to an embodiment, the running of the application with the additional resource on the shadow system is concurrent with the running of the application on the cloud system, the shadow cloud system being different from the cloud system of the user.

According to an embodiment, the running including running the application with the resource on the shadow cloud system, prior to the running of the application with the additional resource, wherein the running of the application with the resource determines the base performance of the resource on the shadow cloud system.

According to an embodiment, the method further includes comparing the base performance of the resource with the additional base performance of the additional resource on the shadow cloud system so as to define the performance gain of the additional resource on the shadow cloud system.

According to an embodiment, each of the resource and the additional resource of the at least one resource includes utilizing of a specialized hardware, and the performance gain enhances utilization of the application on the cloud system.

According to an embodiment, the application being executed on the cloud system is at least one of virtual machine (VM), logical partition (LPAR) and virtual environment.

According to an embodiment, the user is a user of multiple users, and the notifying includes notifying the remaining users of the multiple users of the performance gain of the additional resource, and upselling the additional resource to the remaining of the multiple users.

According to an embodiment, the additional resource includes a first additional resource and a second additional resource, wherein the running includes discretely running the application with each of the first additional resource and the second additional resource to determine an optimal performance of each of the first and the second additional resource on the shadow cloud system.

According to an embodiment, the method further comprises evaluating the optimal performance of each of the first and the second additional resources to determine a discrete additional base performance of each of the first and the second additional resources; comparing the discrete additional base performance of each of the first and the second additional resources with the base performance of the application to identify either the first additional resource or the second additional resource having the performance gain on the shadow cloud system; and upselling only either the first additional resource or the second additional resource having the performance gain to the user on the cloud system.

According to another aspect of the present application, a system of a hybrid cloud environment including multiple cloud system, wherein each of the multiple cloud system includes at least one resource that utilizes an application, the application of a resource of the at least one resource being executed on a cloud system of a user, and the cloud system being a cloud system of the multiple cloud systems of the hybrid cloud environment is provided. The system includes: a memory; and a processor in communications with the memory, wherein the processor of the system is configured to execute one or more programs stored in the memory, the one or more programs including instructions for: monitoring performance of the application for a user to determine a base performance of the resource of the at least one resource on the cloud system; running the application with an additional resource of the at least one resource to determine an additional base performance of the additional resource, the additional base performance being determined on a shadow cloud system of the multiple cloud systems, wherein the additional base performance of the additional resource, at least in part, defines a performance gain of the additional resource on the shadow cloud system; and notifying the user of the performance gain of the additional resource on the cloud system, and upselling the additional resource to the user for enhanced performance of the application.

According to yet another aspect of the present application, a computer program product for improving resource performance in a hybrid cloud environment, wherein the hybrid cloud environment includes multiple cloud systems, each of which includes at least one resource that utilizes an application, wherein the application of a resource of the at least one resource is executed on a cloud system of a user, and the cloud system being a cloud system of the multiple cloud systems of the hybrid cloud environment is provided. The computer program product includes: a computer-readable storage medium storing program instructions readable by a processor, and storing instructions for execution by the processor for performing a method including: monitoring performance of the application for a user to determine a base performance of the resource of the at least one resource on the cloud system; running the application with an additional resource of the at least one resource to determine an additional base performance of the additional resource, the additional base performance being determine on a shadow cloud system of the multiple cloud systems, wherein the additional base performance on a shadow cloud system of the multiple cloud systems, wherein the additional base performance of the additional resource, at least in part, defines a performance gain of the additional resource on the shadow cloud system; and notifying the user of the performance gain of the additional resource on the cloud system, and upselling the additional resource to the user for enhanced performance of the application.

A method, computer system and/or computer program product for performing the following operations (not necessarily in the following order): (i) receiving, from a first user, by a computing resources service provider and over a communication network, a request to perform a first set of computer work; (ii) responsive to receipt of the request, determining, by the computing resources service provider, a first set of network implemented computing resource(s) (NICR(s)) to be used to perform the first set of computer work on behalf of the first user, based on a service plan of the first user; (iii) responsive to receipt of the request, performing, by the computing resources service provider, the first set of computer work, on behalf of the first user, on the first set of NICR(s); (iv) generating, by the first computing resources service provider, a first performance data set including information indicating a set of performance value(s) that characterize quality and/or price of the performance of the first set of computer work on the first set of NICR(s); (v) performing, by the computing resources service provider, the first set of computer work on a second set of NICR(s), with the second set of NICR(s) being different than the first set of NICR(s); (vi) generating, by the first computing resources service provider, a second performance data set including information indicating a set of performance value(s) that characterize quality and/or price of the performance of the first set of computer work on the second set of NICR(s); (vii) determining, by the first computing resources service provider, that the quality and/or price of performing the first set of computer work on the first set of NICR(s) is different than the quality and/or price of performing the first set of computer work on the second set of NICR(s); and (viii) responsive to the determination that the quality and/or price is different, taking, by the first computing resources service provider, a responsive action regarding the service plan of the first user.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a cloud computing node, in accordance with an aspect of the present invention.

FIG. 2 depicts one embodiment of a cloud computing environment, in accordance with an aspect of the present invention.

FIG. 3 depicts one example of abstraction model layers, in accordance with an aspect of the present invention.

FIG. 4 depicts one embodiment of a system for improving resource performance in a hybrid cloud environment, in accordance with an aspect of the present invention.

FIG. 5 illustrates a flowchart that describes a method for improving resource performance in a hybrid cloud environment, in accordance with an aspect of the present invention.

### DETAILED DESCRIPTION

The present invention is directed to, inter alia, embodiments of a method, a system and a computer program product for improving resource performance in a hybrid cloud environment which includes, for instance, multiple cloud systems, such as, public, community and/or private cloud systems. By way of example, the present invention relates to, for instance, improving resource performance in a hybrid cloud environment by analyzing the application that is executed on a private cloud system (referred to herein as a “cloud system”) for a user to determine whether the application might benefit from additional resources, and running the application with additional resources concurrently on a public cloud system (referred to herein as a “shadow cloud system”), and comparing the performances of both the resource and the additional resource to identify and/or define a performance gain of the additional resource on the shadow system. Advantageously, such a performance gain of the additional resource on the shadow system allows a cloud service provider to focus on resources that actually benefits the user, while also enabling to make commercial gains by upselling the additional resource, for instance, for an additional price. As used herein, “upselling” refers to a sales technique that allows a cloud service provider to persuade and/or convince a user to purchase an upgrade, such as, additional resource, that provides additional benefits so as to improve performance of the cloud resource on the system, thereby enhancing the performance efficiency of the application.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

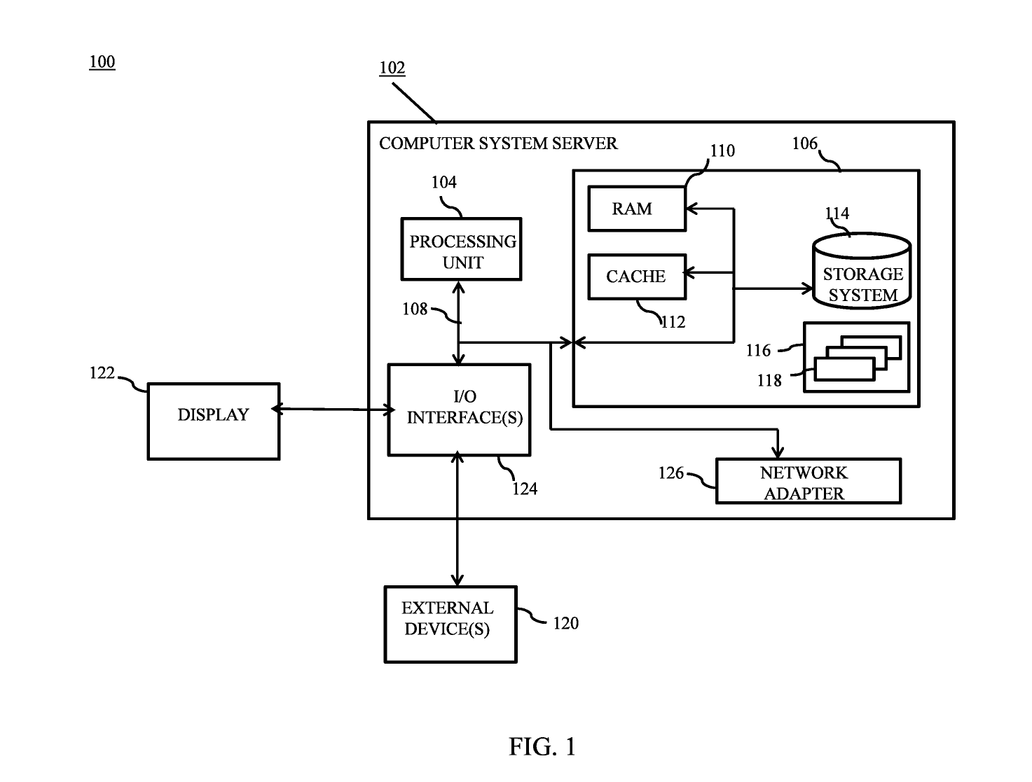

Referring now to FIG. 1, a schematic of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth herein.

In cloud computing node 100, there is a computer system/server 102, which is operational with numerous other general purpose or special purpose computing system environments or configurations. Examples of well-known computing systems, environments, and/or configurations that may be suitable for use with computer system/server 102 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 102 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 102 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 102 in cloud computing node 100 is shown in the form of a general-purpose computing device. The components of computer system/server 102 may include, but are not limited to, one or more processors or processing units 104, a system memory 106, and a bus 108 that couples various system components including system memory 106 to processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 102 typically includes a variety of computer system readable media. Such media may be any available media that is accessible by computer system/server 102, and it includes both volatile and non-volatile media, removable and non-removable media.

System memory 106 can include computer system readable media in the form of volatile memory, such as random access memory (RAM) 110 and/or cache memory 112. Computer system/server 102 may further include other removable/non-removable, volatile/non-volatile computer system storage media. By way of example only, storage system 114 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 108 by one or more data media interfaces. As will be further depicted and described below, memory 106 may include at least one program product having a set (e.g., at least one) of program modules that are configured to carry out the functions of embodiments of the invention.

Program/utility 116, having a set (at least one) of program modules 118, may be stored in memory 106 by way of example, and not limitation, as well as an operating system, one or more application programs, other program modules, and program data. Each of the operating system, one or more application programs, other program modules, and program data or some combination thereof, may include an implementation of a networking environment. Program modules 118 generally carry out the functions and/or methodologies of embodiments of the invention as described herein.

Computer system/server 102 may also communicate with one or more external devices 120 such as a keyboard, a pointing device, a display 122, etc.; one or more devices that enable a user to interact with computer system/server 102; and/or any devices (e.g., network card, modem, etc.) that enable computer system/server 102 to communicate with one or more other computing devices. Such communication can occur via Input/Output (I/O) interfaces 124. Still yet, computer system/server 102 can communicate with one or more networks such as a local area network (LAN), a general wide area network (WAN), and/or a public network (e.g., the Internet) via network adapter 126. As depicted, network adapter 126 communicates with the other components of computer system/server 102 via bus 108. It should be understood that although not shown, other hardware and/or software components could be used in conjunction with computer system/ server 102. Examples, include, but are not limited to: microcode, device drivers, redundant processing units, external disk drive arrays, RAID systems, tape drives, and data archival storage systems, etc.

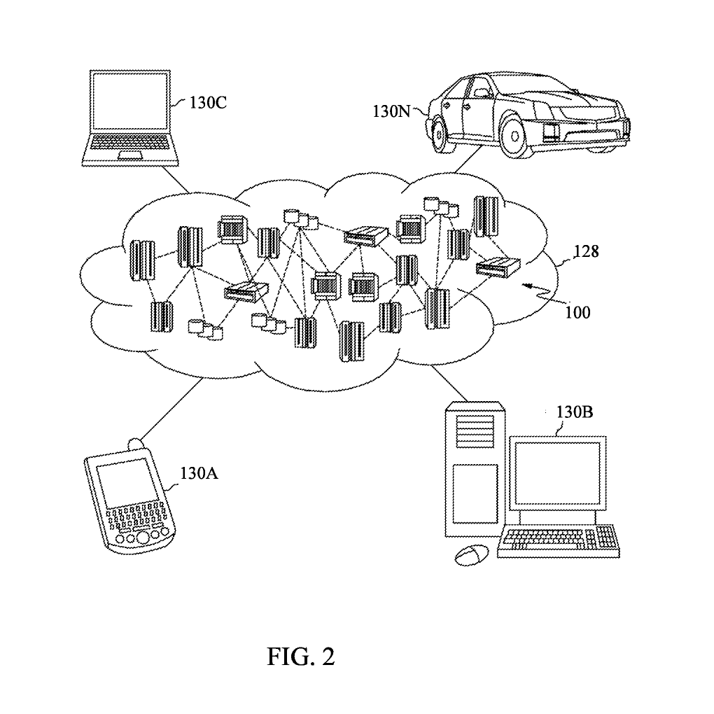

Referring now to FIG. 2, illustrative cloud computing environment 128 is depicted. As shown, cloud computing environment 128 comprises one or more cloud computing nodes 100 with which local computing devices used by cloud consumers, such as, for example, personal digital assistant (PDA) or cellular telephone 130A, desktop computer 130B, laptop computer 134C, and/or automobile computer system 134N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 128 to offer infrastructure, platforms and/or software as services for which a cloud consumer does not need to maintain resources on a local computing device. It is understood that the types of computing devices 130A-N shown in FIG. 2 are intended to be illustrative only and that computing nodes 100 and cloud computing environment 128 can communicate with any type of computerized device over any type of network and/or network addressable connection (e.g., using a web browser).

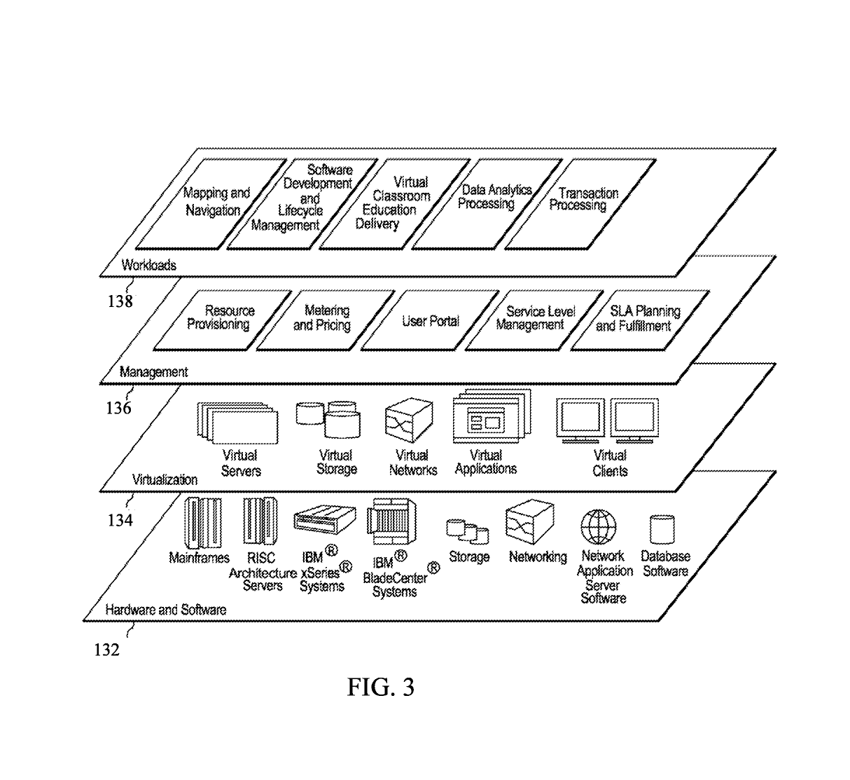

Referring now to FIG. 3, a set of functional abstraction layers provided by cloud computing environment 128 (FIG. 2) is shown. It should be understood in advance that the components, layers, and functions shown in FIG. 3 are intended to be illustrative only and embodiments of the invention are not limited thereto.

As depicted, the following layers and corresponding functions are provided:

Hardware and software layer 132 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, Web Sphere, and DB2 are trademarks of International Business Machines Corporation registered in many jurisdictions worldwide).

Virtualization layer 134 provides an abstraction layer from which the following examples of virtual entities may be provided: virtual servers; virtual storage; virtual networks, including virtual private networks; virtual applications and operating systems; and virtual clients.

In one example, management layer 136 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 138 provides examples of functionality for which the cloud computing environment may be utilized. Examples of workloads and functions which may be provided from this layer include: mapping and navigation; software development and lifecycle management; virtual classroom education delivery; data analytics processing; transaction processing; and allocating resources.

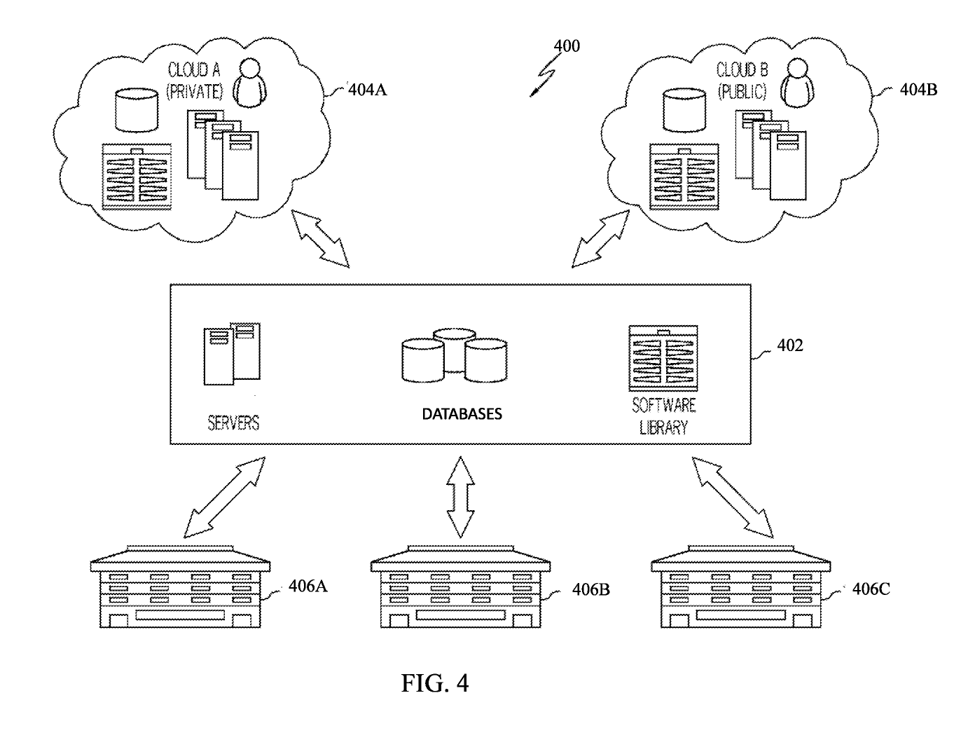

FIG. 4 illustrates an example of a system 400 for improving resource performance, for instance, in a hybrid cloud environment 128 (see FIG. 2), in accordance with one or more aspects of the present invention. As depicted, system 400, in one example, may include a cloud service provider 402 that communicates with one or more cloud systems 404A & 404B and with one or more users 406A, 406B & 406C, for instance, via a network infrastructure, such as, the Internet (not shown). By way of example, and as described above, the cloud systems may include a private cloud system (referred to herein as “cloud system 404A”), and a public cloud system (referred to herein as “shadow cloud system 404B”). Note that, in one embodiment, the public cloud system 404B may be utilized as a shadow cloud system to carry out the functions and/or methodologies of embodiments of the invention described herein. Alternatively, in another embodiment, an additional cloud system (not shown) that is similar to the public cloud system 404B may also be utilized as a shadow cloud system. Further, although not depicted in FIG. 4, one skilled in the art will understand, that cloud service provider 402 may also communicate with one or more software providers (not shown). For instance, cloud service provider 402 may include one or more infrastructures, such as, servers, databases, and/or libraries. As understood, such infrastructure enables the cloud service provider 402 to store information for providing the functionality recited herein.

Continuing with FIG. 4, cloud service provider 402 may include one or more computer systems, such as computer system 102 (see FIG. 1), described above in connection with FIG. 1. Note that, in one embodiment, although not depicted in the figures, the memory 106 (see FIG. 1) of the computer system 102 (see FIG. 1) for the cloud service provider 402 may include one or more virtual machines (not shown), one or more logical partitions (not shown) or one or more virtual environments (not shown). As one skilled in the art will understand, virtual machine (not shown) and/or logical partition (not shown) hosted on the cloud system 404A of the cloud service provider 402 may function as a separate computer application system used to create a virtual environment allowing user(s) 406A, 406B & 406C to run multiple operating systems (not shown) at the same time through the use of software located on the cloud system.

Continuing further with FIG. 4, one or more users 406A, 406B& 406C may utilize one or more applications (not shown) that are hosted on a cloud system, such as, cloud system 404A of the cloud service provider 402, and are run with one or more shared resources (referred to herein as “resource”), such as, a reconfigurable hardware (e.g. Field Programmable Gate Array(FPGAs)). As described above, the application(s) of the user 402 may be accessible using service models, such as, software as a service (SaaS). By way of example, the application(s) that are executed on the cloud system 404A may include, but not limited to, virtual machine (not shown), logical partition (not shown), virtual environments and the like. In accordance with one or more aspects of the present invention, a processor(s) 104 (see FIG. 1) of the computer system 102 (see FIG. 1) associated with the cloud service provider may be configured to monitor an optimal performance (for instance, efficiency, utility) of the application (not shown) for a user, for example, user 406A on the cloud system 404A. In one embodiment, the processor 104 (FIG. 1) configured to monitor performance can, for instance, be looking at overall execution time to complete a task that has a defined start and end boundary. In other embodiments rather than simply timing the process, the monitoring of the performance may include checking for I/O counts, network latency, memory utilization and/or a plethora of other high level performance metrics. In one aspect, such monitoring of the optimal performance of the application facilitates defining a base performance of the resource on the cloud system 404A. Note that, as one skilled in the art will understand, the application(s) (not shown) utilized by a user, such as, user(s) 406A, 406B & 406C, are often tested on a public cloud system, for example, shadow cloud system 404B, prior to being hosted on the cloud system 404A. This, for instance, enables the processor 104 (FIG. 1) associated with the cloud service provider 402 to define a base performance of the application on the shadow cloud system 404B as well.

According to an embodiment, the processor 104 (see FIG. 1) of the computer system 102 associated with the cloud service provider 402 may be configured to run the application with one or more improved resource(s) (referred to herein as “additional resource”) on the shadow cloud system 404B in concurrent with running the application with the resource on the cloud system 404A. In one example, the additional resource (e.g. similar to the FPGA described above) may be configured to more rapidly perform specific calculations more rapidly and a general process CPU that can execute them. Another example of the additional resource would include a resource with specialized capabilities that are available on only some processors which mean they can more rapidly do certain type of processing. By way of example, upon running the application with additional resource (not shown) on shadow cloud system 404A, the processor 104 (FIG. 1) may be configured to determine an optimal performance of the additional resource on the shadow cloud system 404B which, for instance, may be significantly different from the optimal performance of the resource on the cloud system 404A. In such an example, the optimal performance of the additional resource on the shadow cloud system 404B may be defined as an additional base performance of the additional resource on the shadow cloud system 404B. Note that, in an enhanced embodiment, the additional base performance of the additional resource on the shadow cloud system 404B may be compared with the base performance of the resource on the cloud system 404A, and may be found to have enhanced efficiency relative to the base performance of the resource on the cloud system 404A, which, for instance, facilitates defining the performance gain of the additional resource on the shadow cloud system 404B. In such embodiment, the performance gain of the additional resource may, for example, enhance utilization of the application on the cloud system that it is hosted upon. Alternatively, it may also be the case that the additional base performance of the additional resource on the shadow cloud system 404B may be found to have efficiency that is lower than the base performance of the resource on the cloud system 404A. Note that, in an additional or alternate embodiment, the additional base performance of the additional resource on the shadow cloud system 404B may be compared with the base performance of the resource determined on the shadow cloud system 404B so as to determine the performance gain of the additional resource on the shadow cloud system 404B.

Referring still further to FIG. 4, upon determining the performance gain of the additional resource on the shadow cloud system 404B, the cloud service provider 402, in one embodiment, may notify the user (for instance, user 406A) of the performance gain of the additional resource on the shadow cloud system 404B, thereby persuading the user 406A to purchase an upgrade so as to supplement the user's resource. Such an upgrade, for instance, may enhance utilization of the application on the cloud system 404A and, in turn, allows the cloud service provider 402 to upsell the additional resource on the cloud system 404A; thereby improving performance efficiency of the resource on the cloud system 404A.

In yet another embodiment, the processor 106 (FIG. 1) may also be configured to discretely run the application with more than one additional resource (not shown) on the shadow cloud system 404B in concurrent with running the application with the resource on the cloud system 404A. Advantageously, such discrete running of multiple resources, for instance, allows for determining the optimal performance of each of the corresponding additional resources (not shown) discretely. The processor 106 (FIG. 1) may be further configured to evaluate the optimal performance of each of the multiple additional resources so as to determine their corresponding additional base performances. Still further, the processor 106 (FIG. 1) may be configured to compare each additional base performance of the multiple additional resources discretely with the base performance of the resource either on the shadow cloud system 404B or on the cloud system 404A (for example, as described above) so as to determine which additional resource of the multiple additional resources exhibits enhanced performance efficiency (i.e., a performance gain) relative to that of the resource. Note that, the information regarding the performance gain (and/or lack thereof) of each of the multiple additional resources on the shadow cloud system 404B may be maintained, in one embodiment, at a database (FIG. 4) associated with the cloud service provider 402. Advantageously, this information may be utilized by the cloud service provider 402 to upsell only those additional resources that exhibit marked improvement, while abandoning those additional resources that lack the performance gain over the resource.

Additionally, or alternatively, in another embodiment depicted in FIG. 4, the cloud service provider 402 may subsequently notify the remaining users (e.g. users 406B & 406C) of the performance gain of the additional resource on the shadow cloud system 404B, and the benefits that the user (e.g. user 406A) derives from the additional resource that is supplementing the user's resource. This, in turn, allows the cloud service provider 402 to upsell the additional resource to the remaining users as well.

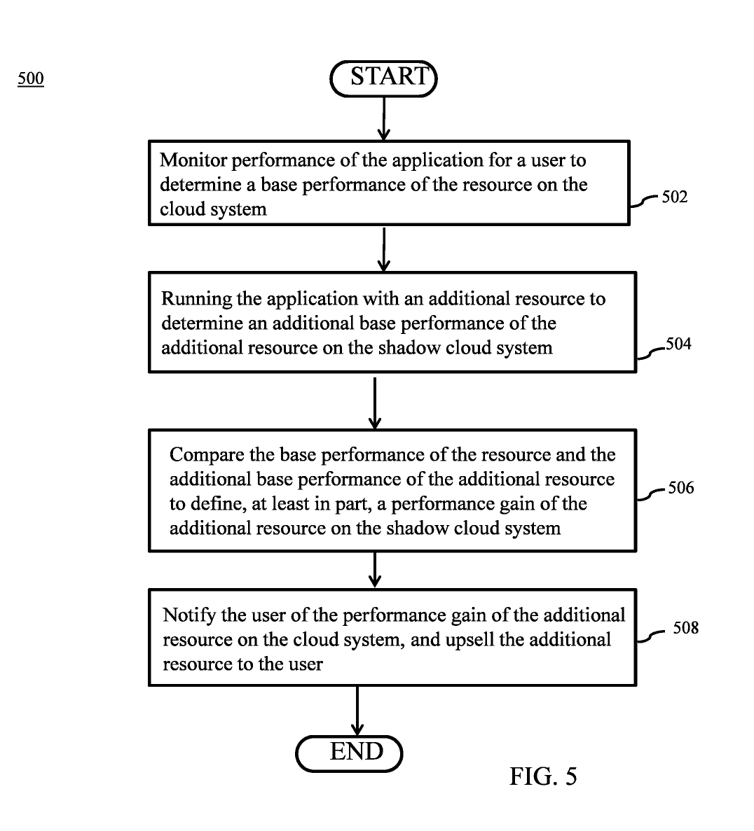

In one embodiment, the methods shown in FIG. 5 may be implemented as hardware (referred to herein as “resource”) on a reconfigurable hardware, e.g., FPGA (Field Programmable Gate Array), or CPLD (Complex Programmable Gate Array), by using a hardware description language (e.g., Verilog, VHDL, Handel-C, or System C). In another embodiment, the methods show in FIG. 5 may also be implemented on other systems that have alternative libraries to link to the additional cloud systems that provide the same interface as the one on the original cloud system. In other words, the library is compiled for the particular processor it is to be run with and thus can take advantage of the advanced capabilities of that processor. For example, when special processing units are provided on as part of the CPU. Alternatively, the library could be dynamically updated/configured to utilize a resource when it is available, such as when a GPU is available.

Some embodiments of the present invention recognize the following facts, potential problems and/or potential areas for improvement with respect to the current state of the art: (i) enterprises are building larger, more heterogeneous cloud environment; (ii) hybrid clouds are more likely to contain a variety of hardware and may also have access to additional resources like FPGAs (field programmable gate arrays); (iii) often applications are first tested on the public cloud and then moved into internal clouds that utilize similar hardware; (iv) users of the public cloud are not always aware of what additional hardware (such as FPGAs) would be of benefit to their application; (v) while these applications are being run in the public cloud there is an opportunity for the cloud provider to: (a) evaluate if additional hardware would be of benefit, (b) provide an opportunity for customers to try it out and/or (c) help upsell when the private cloud is purchased; (vi) some currently conventional systems look at the available hardware and shadow VMs (virtual machines) and keep the one that performs better, but these do not: (a) use analytics to determine what factors make the additional hardware likely to improve the performance, (b) use the analysis to make recommendation(s) to the customer and/or (c) drive a determination of additional hardware to use when shadowing to gather more data.

Some embodiments of the present invention recognize the following facts, potential problems and/or potential areas for improvement with respect to the current state of the art: (i) currently conventional experimentation at the VM level for resources such as memory, processors, etc. (that is, the resources that are dynamically changeable by migration) does not consider the impact on the entire cloud; and/or (ii) as an example of the previous list item, using larger, more powerful machines for the compute nodes or adding one or more pieces of specialized hardware does not consider the impact on the entire cloud.

Some embodiments of the present invention may include one, or more, of the following features, characteristics and/or advantages: (i) analyze the code that users are running over a computer network (for example, on a cloud); (ii) provide suggestions for better available resources in the computer network (for example, in the cloud) for the code being run; and/or (iii) upselling computer network (for example, cloud) users opportunities to get better performance for their code.

In an embodiment of the present invention, a user is running a job in a cloud. The job could benefit from running on a node with an FPGA. A computing resource recommendation system determines this potential benefit, and, in response, informs the user of the opportunity to run on the improved hardware (this may, or may not, involve payment or additional payment). Additionally, this embodiment helps enable a cloud provider's cloud offerings to up sell its customers by: (i) noting how other users are benefitting from the cloud provider's hardware resources (for example, running on hardware that utilizes especially powerful processors or using better storage resources); and/or (ii) highlighting how adding, or substituting in, additional hardware could allow customers to better serve their customers.

In an embodiment of the present invention, this comparison is performed by running a customer's code on a “shadow system.” This shadow system would include a configuration of computing resources (for example, hardware) that is different than the “currently-specified computing resource configuration” the customer is using to actually run its code in the normal course. The performance, as between the “shadow computing resources configuration” and the “currently-specified computing resource configuration,” is compared. On condition that the “shadow computing resource configuration” outperforms the “currently-specified computing resource configuration,” computing resources present in the “shadow computing resources configuration,” but not in the “currently-specified computing resources configuration,” would be recommended to the user. The use of the recommended computing resources may, or may not, involve an additional payment by the user. When the use of the recommended computing resources does involve an additional payment, then this situation is herein sometimes referred to as “upselling.”

In other embodiments, the “shadow computing resources configuration” may actually perform the same, or even slightly less well, than the “currently-specified computing resources configuration,” but, the recommendation system may recommend a configuration change to the user anyway. For example, this would make sense in a situation where the computing resources of the shadow configuration only slightly underperform, but would cost the customer a lot less money such that the benefit of using computing resources of the shadow configuration might be deemed, by the customer, to outweigh the cost of the slightly degraded performance.

In some embodiments, profiling is performed to determine the identity of applications that are helped by the various computing resources of the shadow configuration. This profiling can help more accurately identify exactly which computing resources of the shadow configuration are likely to benefit the customer with respect to performance and/or cost. VMs that do not show improvement would be abandoned quickly and the side resource applied to comparison with a different VM.

Some embodiments of the present invention may include one, or more, of the following features, characteristics and/or advantages: (i) determination of conditions where the addition of resources, such as specialized hardware, would benefit an application so that it can be safely recommended to the consumer; (ii) while the customer is experimenting with or running on computing resources administered by a cloud services provider, determination of situations where the customer would benefit from the addition of resources; (iii) determination of additional beneficial resources leads to a self-managed customer cloud; (iv) it has become difficult to determine the actual benefit of the addition of resources, so this is preferably done as soon as possible; (v) analyzing the customer application running on the cloud to determine if it might benefit from the additional resources and then in parallel, creating a parallel application that uses the additional resource and measures the actual effect of its use; (vi) allows a provider to focus on resources that they want to upsell; (vii) dynamically determine a benefit that can be realized through the expedient of additional resources; (viii) does not rely on static analysis and experience (which approach makes it difficult to quantify and ensure the benefit); and/or (ix) works with both “on-premise clouds” and “non-on-premise clouds.”

In some embodiments, when a customer is starting out with their application on cloud platform for building, running, and managing apps and services, the customer uses sanitized data to test out there application and before the customer is willing to move to an on-premise cloud. In some embodiments, a cloud services provider can provide recommendations on additional resources to include when the customer sets up its on-premise cloud. For clouds that continue to be managed by the cloud services provider, this can be used any time during the period of management to determine which resources would be beneficial and suggest the customer as addition(s) to pay for. In addition to adding individual pieces of specialized hardware, the level of service of hardware can also be done. For example, the customer may be paying for a third rate level service and some embodiments of the present invention inform the customer of the likely benefit of moving to first or second rate.

Some embodiments of the present invention may include one, or more, of the following features, characteristics and/or advantages: (i) can be run to compare clouds; (ii) actually look at the code that the customer is running and which is being shadow run; (iii) don't actually look at the code that the customer is running and which is being shadow run; (iv) if the code being run is available, some embodiments of the recommendation system will scan for specific uses of things, such as XSLTVM, or other patterns and use that to determine what to try; (v) in some embodiments that do not have direct access to the code being run by the customer, the recommendation system will simply try things and gather data about the application and the impact of the additional resource to build a classification system (for example, for certain IO (input/output) characteristics a different storage solution would be potentially beneficial).

Some embodiments of the present invention may include one, or more, of the following operations, characteristics, features and/or advantages: (i) identification of resources that improve performance for cloud (Software as a Service (SaaS)) for offering usage for a charge (for example, upselling) to a user of the cloud; (ii) monitoring performance of one or more applications for a user executing on a cloud system to determine a base performance and a predicted improvement based on a resource change; (iii) testing the one or more applications against cloud resources including the resource change to identify an actual performance gain different from the base performance; (iv) providing a notification to the user of the opportunity for the actual performance gain for the one or more applications based on the resource change and a charge for utilizing the resource change; (v) the resource change is a utilizing of specialized hardware (for example, an FPGA) and the actual performance gain is for utilization of the one or more applications on the cloud system; (vi) the actual performance gain is determined on a separate cloud system running the one or more applications concurrently with the cloud system; (vii) determining a first set of applications (and/or portions of applications) showing net improvement on the separate cloud system and a second set of application (and/or portions of applications) not showing a net improvement from the separate cloud system; (viii) segregating the first set of applications from the second set of applications; (ix) associating the actual performance gain with the first set of application; (x) the first set of applications (and/or portions of applications) and the second set of applications (and/or portions of applications) are selected from a group consisting of virtual machines (VMs), logical partitions (LPARs), and virtual environments; (xi) testing may be broken down into several pieces where in the background testing is performed with new software configurations and or hardware configurations; (xii) in some environments down level software could be less expensive; and/or (xiii) as those of skill in the art will appreciate, there are differences between moving an entire application and part of an application (however, as used herein, the term “application” is hereby defined broadly to mean a proper entire application or just a part of an application).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of improving resource performance in a hybrid cloud environment, wherein the hybrid cloud environment comprises multiple cloud systems, each of which comprises at least one resource that utilizes an application, wherein the application of a resource of the at least one resource is executed on a cloud system of a user, and the cloud system being a cloud system of the multiple cloud systems of the hybrid cloud environment, the method comprising:
monitoring performance of the application for a user to determine a base performance of the resource of the at least one resource on the cloud system;
running the application with an additional resource of the at least one resource to determine an additional base performance of the additional resource, the additional base performance being determined on a shadow cloud system of the multiple cloud systems, wherein the additional base performance of the additional resource, at least in part, defines a performance gain of the additional resource on the shadow cloud system; and
notifying the user of the performance gain of the additional resource on the cloud system, and upselling the additional resource to the user for enhanced performance of the application.

2. The method of claim 1, wherein the running of the application with the additional resource on the shadow cloud system is concurrent with the running of the application on the cloud system, the shadow cloud system being different from the cloud system of the user.

3. The method of claim 2, wherein the running comprises running the application with the resource on the shadow cloud system, prior to the running of the application with the additional resource, wherein the running of the application with the resource determines the base performance of the resource on the shadow cloud system.

4. The method of claim 3, further comprising comparing the base performance of the resource with the additional base performance of the additional resource on the shadow cloud system so as to define the performance gain of the additional resource on the shadow cloud system.

5. The method of claim 1, wherein each of the resource and the additional resource of the at least one resource comprises utilizing of a specialized hardware, and the performance gain enhances utilization of the application on the cloud system.

6. The method of claim 1, wherein the application being executed on the cloud system is at least one of virtual machine (VM), logical partition (LPAR) and virtual environment.

7. The method of claim 1, wherein the user is a user of multiple users, and the notifying comprises notifying the remaining users of the multiple users of the performance gain of the additional resource, and upselling the additional resource to the remaining of the multiple users.

8. The method of claim 1, wherein the additional resource comprises a first additional resource and a second additional resource, wherein the running comprises discretely running the application with each of the first additional resource and the second additional resource to determine an optimal performance of each of the first and the second additional resources on the shadow cloud system.

9. The method of claim 8, further comprising:
evaluating the optimal performance of each of the first and the second additional resources to determine a discrete additional base performance of each of the first and the second additional resources; and
comparing the discrete additional base performance of each of the first and the second additional resources with the base performance of the application to identify either the first additional resource or the second additional resource having the performance gain on the shadow cloud system: and
upselling only either the first additional resource or the second additional resource having the performance gain to the user on the cloud system.

10. A computer program product for improving resource performance in a hybrid cloud environment, wherein the hybrid cloud environment comprises multiple cloud systems, each of which comprises at least one resource that utilizes an application, wherein the application of a resource of the at least one resource is executed on a cloud system of a user, and the cloud system being a cloud system of the multiple cloud systems of the hybrid cloud environment, the computer program product comprising:
a computer-readable storage structured to store machine readable computer code; and
computer code stored on the storage medium;
wherein the computer code includes program instructions and data for causing the processor(s) set to perform operations including at least the following:
monitoring performance of the application for a user to determine a base performance of the resource of the at least one resource on the cloud system;
running the application with an additional resource of the at least one resource to determine an additional base performance of the additional resource, the additional base performance being determined on a shadow cloud system of the multiple systems, wherein the additional base performance of the additional resource, at least in part, defines a performance gain of the additional resource on the shadow cloud system; and
notifying the user of the performance gain of the additional resource on the cloud system, and upselling the additional resource to the user for enhanced performance of the application.

11. The computer program product of claim 10, wherein each of the resource and the additional resource of the at least one resource comprises utilizing a specialized hardware, and the performance gain of the additional resource enhances utilization of the application on the cloud system of the user.

12. The computer program product of claim 10, wherein the user is a user of multiple users, and the notifying comprises notifying the remaining users of the multiple users of the performance gain of the additional resource, and upselling the additional resource to the remaining of the multiple users.

13. The computer program product of claim 10 further comprising the processor(s) set, wherein:
the computer program product is in the form of a computing system.

14. The computer program product of claim 13, wherein the user is a user of multiple users, and the notifying comprises notifying the remaining users of the multiple users of the performance gain of the additional resource, and upselling the additional resource to the remaining of the multiple users.

15. A method comprising:
receiving, from a first user, by a computing resources service provider and over a communication network, a request to perform a first set of computer work;
responsive to receipt of the request, determining, by the computing resources service provider, a first set of network implemented computing resource(s) (NICR(s)) to be used to perform the first set of computer work on behalf of the first user, based on a service plan of the first user
responsive to receipt of the request, performing, by the computing resources service provider, the first set of computer work, on behalf of the first user, on the first set of NICR(s);
generating, by the first computing resources service provider, a first performance data set including information indicating a set of performance value(s) that characterize quality and/or price of the performance of the first set of computer work on the first set of NICR(s);
performing, by the computing resources service provider, the first set of computer work on a second set of NICR(s), with the second set of NICR(s) being different than the first set of NICR(s);
generating, by the first computing resources service provider, a second performance data set including information indicating a set of performance value(s) that characterize quality and/or price of the performance of the first set of computer work on the second set of NICR(s);
determining, by the first computing resources service provider, that the quality and/or price of performing the first set of computer work on the first set of NICR(s) is different than the quality and/or price of performing the first set of computer work on the second set of NICR(s); and
responsive to the determination that the quality and/or price is different, taking, by the first computing resources service provider, a responsive action regarding the service plan of the first user.

16. The method of claim 15 wherein the responsive action includes:
recommending, by the computing resources service provider, over the communication network and to the first user, that the first user should consider changing the first user's service plan in a manner such that the recommended manner of change would mean that the second set of NICR(s) would be used to service requests similar to the first set of computing work on condition that the service plan was changed in the recommended manner.

17. The method of claim 16 wherein:
the determination that the quality and/or price is different determines that performance is better on the second set of NICR(s); and
the recommended change is an upsell.

18. The method of claim 16 wherein:
the determination that the quality and/or price is different determines that a price of performance, with respect to the first set of computer work, is lower on the second set of NICR(s).

19. The method of claim 15 wherein:
the computing resources service provider is a cloud computing resources service provider;
the communications network includes a cloud; and
the first set of NICR(s) includes a computing resource implemented in the cloud.

20. The method of claim 15 wherein the performance value(s) include at least one of the following types of values relating to quality: speed of completion of the first set of computer work, accuracy of outputs of the first set of computer work, CPU utilization, memory usage, memory swapping, disk usage, disk I/O, network usage.
